(19) United States
(12) Patent Application Publication
(10) Pub. No.: US 2006/0181538 A1
(43) Pub. Date: Aug. 17, 2006

(54) Displaying apparatus and data writing device

(75) Inventor: Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/335,628

(22) Filed: Jan. 20, 2006

(30) Foreign Application Priority Data
Jan. 20, 2005 (KR) 2005-0005274

(51) Int. Cl. G06F 15/16

(52) U.S. Cl. 345/502

(57) ABSTRACT

The present invention relates to a displaying apparatus communicating with a video source through a DPVL mechanism, comprising a plurality of interface units to receive video signals respectively received from a plurality of video sources supporting the DPVL mechanism; a signal processing unit to process the respective video signals received from the plurality of video sources; a frame buffer to store therein frame information corresponding to the respective video signals; and a display controller to write changed data of each DPVL video signal received from the plurality of video sources and processed in the signal processing unit, on the positions of the frame information stored in the frame buffer, corresponding to each changed data, and displaying a video image according to the written frame information with the changed data of the respective DPVL video signals. Thus, embodiments of the present invention provide a displaying apparatus capable of receiving a DPVL video signal from a plurality of video sources and displaying data of each DVPL video signal, and a device to write the data.

### CROSS-REFERENCE TO RELATED APPLICATIONS

This application claims the benefit under 35 U.S.C. §119(a) of Korean Patent Application No. 2005-0005274, filed on Jan. 20, 2005, in the Korean Intellectual Property Office, the entire disclosure of which is hereby incorporated by reference.

### BACKGROUND OF INVENTION

1. Field of Invention

The present invention relates to a displaying apparatus capable of communicating with a video source through a digital packet video link (DPVL). More particularly, the present invention relates to a displaying apparatus capable of receiving DPVL video signals from a plurality of video sources and displaying data of each DPVL video signal, and a device to write the data.

2. Description of the Related Art

Recently, there has been a growing tendency that computer systems employ a DPVL Standard to improve a limitation on transmission speed resulting from transmitting large-sized video data with high resolution to a displaying apparatus, as a communication mechanism to transmit and receive data between a computer main body and a displaying apparatus.

A communication between the computer main body and the displaying apparatus to support this DPVL Standard will be briefly described with reference to FIG. 1. A computer main body (hereinafter referred to as “a video source 15”) comprises a graphic card 10′ to transmit a video signal to a displaying apparatus 100′ according to control by a controller 1 that controls an output of a video signal from the video source 15. The graphic card 10′ comprises a graphic engine 11 to write video data of a video signal to be transmitted to the displaying apparatus 100′, on a source frame buffer 13, and a cathode ray tube controller (CRTC) 12 packetizing only the video data corresponding to an area 14 changed from the former data (hereinafter referred to as “changed area”), among video data of the video signal to be transmitted, from the frame information written on the source frame buffer 13, and transmitting the video data of the changed area 14 to the displaying apparatus 100′. According to this, the video source 15 transmits the DPVL video signal resulting from packetizing only the video signal of the changed area 14; except for the same area 13a from the video signal formerly transmitted, to the displaying apparatus 100′.

The displaying apparatus 100′ includes a display controller 70′. When a video, signal received from the video source 15 and then decoded in a processing unit 40′ is a packetized DPVL video signal, the display controller 70′ writes changed data 14′ on a position on the frame buffer 50′, corresponding to the changed area 14 of the DPVL video signal, and then displays a video image on a display module 30′ based on frame information (consisting of data of the same area as that of the former video signal 13a′+changed data 14′) of the frame buffer 50′. According to this, the displaying apparatus 100′ only changes the changed data 14′ corresponding to the changed area 14 of the DPVL video signal packetized and transmitted, from the former frame information stored in the frame buffer 50′, and displays the frame information according thereto.

As a result, a limitation on transmission speed due to transmission of large-sized video data may be improved in data reception/transmission systems.

However, the displaying apparatus 100′ communicating with a video source through the DPVL Standard described above receives only one DPVL video signal from one video source supporting the DPVL mechanism and displays a video image according thereto. Thus, the conventional displaying apparatus 100′ can only receive one DPVL video signal without respect to a size or a position of the portion on which the changed data 14′ corresponding to the changed area of the DPVL video signal is written.

In this respect, the displaying apparatus 100′ has been unable to utilize the area remaining unchanged as same as the former, except for the portion on which the changed data 14′ is written, because of the DPVL video signal.

### SUMMARY OF THE INVENTION

Accordingly, it is an aspect of the present invention to provide a displaying apparatus capable of receiving a DPVL video signal from a plurality of video source's and displaying data of each DPVL video signal, and a device to write the data.

Additional aspects and/or advantages of the present invention will be set forth in part in the description which follows and, in part, will be obvious from the description, or may be learned by practice of the present invention.

The foregoing and/or other aspects of the present invention are also achieved by providing a displaying apparatus for communicating with a video source through a DPVL mechanism, comprising a plurality of interface units to receive video signals respectively received from a plurality of video sources supporting the DPVL mechanism; a signal processing unit to process the respective video signals received from the plurality of video sources; a frame buffer to store therein frame information corresponding to the respective video signals; and a display controller to write changed data of each DPVL video signal inputted from the plurality of video sources and processed in the signal processing unit, on the positions of the frame information stored in the frame buffer, corresponding to each changed data, and displaying a video image according to the written frame information with the changed data of the respective DPVL video signals.

According to an aspect of the present invention, the displaying apparatus further comprises a user input unit to set up a reference area for displaying priorities of each video signal received from the plurality of video sources by level, wherein the display controller comprises a storage unit to store therein reference area video level information of each video signal set up through the user input unit.

According to an aspect of the present invention, the display controller writes reference area data of each video signal received from the plurality of video sources, on the frame buffer as reference frame information with graduation, according to the reference area video level information stored in the storage unit.

According to an aspect of the present invention, the reference area displaying priority of each video signal comprises a display density on reference area video.

According to an aspect of the present invention, the user input unit further includes a function to set up the priorities of each DPVL video signal received from the plurality of video sources by level, and the display controller stores changed area video level information of each DPVL video signal set up through the user input unit on the storage unit.

According to an aspect of the present invention, the display controller determines whether there exists any overlapped area between writing positions of the respective changed data when writing the changed data of each DPVL video signal on the corresponding positions of the stored frame information, and as a result, when it is determined that any overlapped area exists, it writes the changed data on the corresponding positions of the frame information according to the stored changed area video level information.

According to an aspect of the present invention, the priority of each DPVL video signal comprises a display density on changed area video of each DPVL video signal.

According to an aspect of the present invention, the displaying apparatus further comprises a user input unit to set up a display area of reference video by video source, wherein the display controller comprises a storage unit to store therein display area information of the reference video by video source set up through the user input unit, and writes the video signal corresponding to the display area of the reference video by video source according to the display area information of the reference video by video source, on the frame buffer as reference frame information, among the video signals of the plurality of video sources.

The foregoing and/or other aspects of the present invention are also achieved by providing a device for writing data from a DPVL signal source through a DPVL mechanism on a frame buffer, comprising a plurality of interface units to receive data signals inputted from a plurality of DPVL signal sources supporting the DPVL mechanism; a processing unit to process the data signals inputted from the plurality of DPVL signal sources; and a controller to write changed data corresponding to each DPVL signal inputted from the plurality of DPVL signal sources and processed in the signal processing unit, on the positions corresponding to the changed data of the frame information stored in the frame buffer.

According to an aspect of the present invention, the device further comprises a user input unit to set up the priorities of each DPVL signal received from the plurality of DPVL signal sources, wherein the controller comprises a storage unit to store therein changed area level information of each DPVL signal set up through the user input unit.

According to an aspect of the present invention, the controller determines whether there exists any overlapped area between writing positions of the respective changed data when writing the changed data of each DPVL video signal on the corresponding positions of the stored frame information, and as a result, when it is determined that any overlapped area exists, it writes the changed data on the corresponding positions of the frame information according to the stored changed area video level information.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a conventional communication system with a DPVL video signal;

FIG. 2 is a control block diagram of a communication system with a DPVL video signal according to an embodiment of the present invention;

FIG. 3 illustrates a combined example of writing two DPVL video signals received from two DPVL video sources whose data has changed on a frame buffer of a displaying apparatus according to an exemplary embodiment of the present invention;

FIG. 4 illustrates an example where changed data of each DPVL video signal is written on an overlapped area of the frame buffer; and

FIG. 5 is a control flow chart of a displaying apparatus according to an exemplary embodiment of the present invention.

### DETAILED DESCRIPTION OF EXEMPLARY EMBODIMENTS

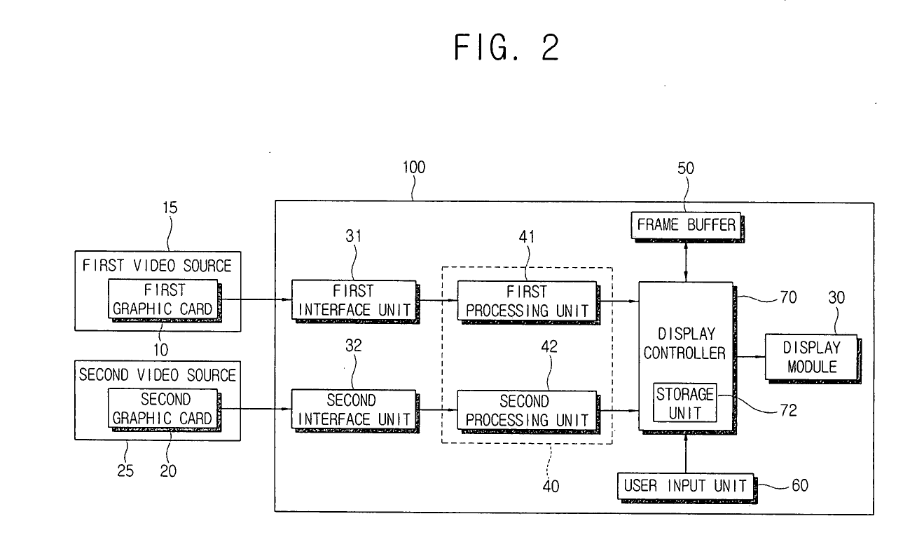

Reference will now be made in detail to embodiments of the present invention, examples of which are illustrated in the accompanying drawings, wherein like reference numerals refer to like elements, features and structures throughout. FIG. 2 is a control block diagram of a communication system with a DPVL video signal, which comprises a displaying apparatus 100 according to an embodiment of the present invention. As illustrated, the DPVL video signal communication system comprises a plurality of video sources 15 and 25, and a displaying apparatus 100.

The plurality of video sources comprise a first video source 15 including a first graphic card 10 to output a first video signal, and a second video source 25 including a second graphic card 20 to output a second video signal, by way of example. Here, the first video source 15 and the second video source 25 may packetize only the video data corresponding to an area changed from the former data, among video data of each video signal (first video signal or second video signal) to thereby output packetized DPVL video signals.

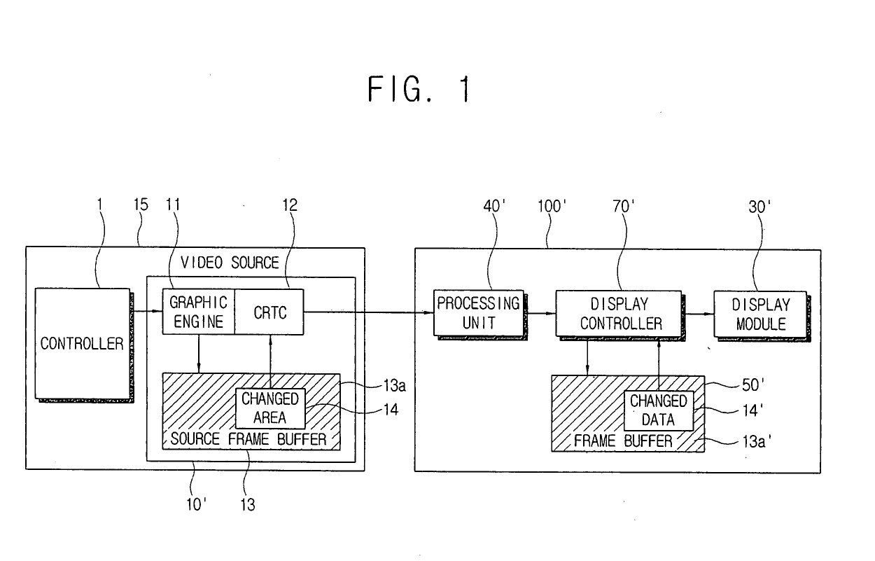

It is preferable that the first video source 15 and the second video source 2 have the same configuration as the video source illustrated in FIG. 1.

The displaying apparatus 100 comprises a display module 30, a first interface unit 31 to receive the first video signal inputted from a first video source 15, a second interface unit 32 to receive the second video signal inputted from a second video source 25, a signal processing unit 40 to decode the first and the second video signals inputted through the first and the second interface units 31 and 32, a frame buffer 30 to store therein frame information corresponding to the received video signals, a user input unit 60 to set up, by level, priorities to display reference areas of the first and the second video signals, and priorities of the first and the second DPVL video signals, and a display controller 70 to write a first changed data and a second changed data of the first and the second DPVL video signals received from the first and the second video sources 15 and 25 and processed in the signal processing unit 40, on the positions corresponding to the first and the second changed data of the frame information already stored in the frame buffer 50, and to control the display module 30 so as to display a video image according to the frame information written with the changed data of the first and the second DPVL video signals.

The display module 30 receives a video signal from the display controller 70 and displays a video image. The display module 30 includes a display panel (not shown) to display a video image thereon, and a panel driving unit (not shown) to process a video signal inputted from the display controller 70 and display the video image on the display panel (not shown). Where the display module 30 refers to a digital light processing (DLP) module, the panel driving unit (not shown) may include an optical lens. As such, it may include a display unit (not shown) and a panel driving unit (not shown) depending upon a type of display.

The first interface unit 31 and the second interface unit 32 may be various in kind if it can be constructed so as to receive a DPVL video signal as received. Typically there is a digital visual interface (DVI) communication port to receive a digital video signal.

The signal processing unit 40 is a functional unit to decode video signals received through the first interface unit 31 and the second interface unit 32, which may be various depending upon the types of received video signals. Where the first interface unit 31 and the second interface unit 32 refer to DVI communication ports, it is preferred that the signal processing unit 40 comprises a transition minimized differential signaling (TMDS) receiving unit which divides a received DVI signal into an RGB digital signal and an HNV synchronous signal. In FIG. 2, the signal processing unit 40 comprises a first processing unit 41 and a second processing unit 42 to respectively process the first video signal and the second video signal received through the first interface unit 31 and the second interface unit 32.

The user input unit 60 is an input functional unit to set up priorities to display the reference areas of the first and the second video signals and priorities to the first and the second DLVL video signals, by level, which may comprise a key input unit (not shown) for key manipulation by a user, and an on screen display (OSD) generating unit (not shown) to generates an OSD priority adjusting menu, thereby adjusting priorities for displaying the reference areas of the first and the second video signals and the priorities of the first and the second DPVL video signals, by level.

For example, the user may select priorities for displaying the reference areas of the first and the second video signals, among the levels of 0%, 50% and 100%, and priorities for the first and the second DPVL image signals, among the levels of 0%, 50% and 100%, through the user input unit 60.

The display controller 70 comprises a storage unit 72 to store therein reference area video level information whereby the reference area displaying priorities of the first and the second video signals are set up, by level, through the user input unit 60, and changed area video level information whereby the priorities for the first and the second DPVL video signals are set up by level through the user input unit 60.

The display controller 70 stores the reference area video level information and the changed area video level information, set up through the user input unit 60, in the storage unit 72.

The display controller 70 writes reference area data of the first and the second video signals initially received from the first and the second video sources 15 and 25 on the frame buffer 50 with graduation as frame information, based on the reference area video level information stored in the storage unit 72. The reference area data refers to data of video signals not corresponding to DPVL video signals, among video data of video signals received.

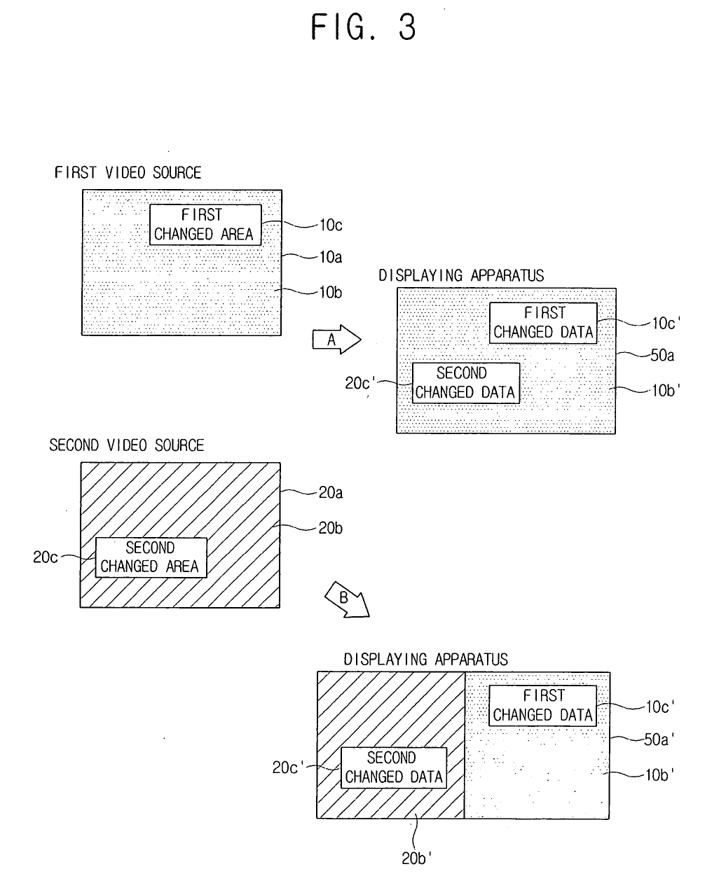

An example of writing the reference area data of the first and the second video signals on the frame buffer 50 with graduation according to the reference area video level information will now be described with reference to FIG. 3.

First, it is assumed that reference area video level information regarding the reference area displaying priority of the first video signal is set as 100% and that of the, second video signal is set up as 0%, and both levels are stored in the storage unit 72. At this time, when the first video signal is received from the first video source 15 and the second video signal from the second video source 25, the display controller 70 writes the reference video data 10a of the first video signal on the frame buffer 50 as frame information 50a according to the reference area video level information (A of FIG. 3). Since the reference video data 20b of the second video signal has the priority of 0%, it is not written on the frame buffer 50. Where the reference area displaying priorities of the first and the second video signals are respectively set up as 50%, it is possible to write them on the frame buffer 50 so as to display a video image of each video signal semi-transparently.

The display controller 70 controls the display module 30 so as to display a video image according to the frame 50a information of the frame buffer 50 written with graduation based on the set up reference area video level information.

It is also possible to set up a display area of the reference video by each of the video sources 15 and 25 through the user input unit 60. The display controller 70 may store display area information of the reference video by the respective video sources 15 and 25 stored through the user input unit 60.

With reference to FIG. 3, an exemplary embodiment will be described under the assumption that the display area information of the reference video is stored in the storage unit. 72. Herein, the display area information of the reference video includes information for the display area (½ on the left) of the reference video of the first video signal and the display area (½ on the right) of the reference video of the second video signal which are set up through the user input unit 60. When the first video signal is received from the first video source 15 and the second video signal is received from the second video source 25, the display controller 70 writes the first video signal corresponding to the display area (½ on the left) of the reference video of the first video signal on the frame buffer 50 as frame information 50a′ and the second video signal corresponding to the display area (½ on the right) of the reference video of the second video signal on the frame buffer 50 as frame information 50a′, according to the display area information of the reference video of each video source (B of FIG. 3).

When the respective DPVL video signals are received from the first and the second video sources 15 and 25, the display controller 70 writes the respective changed data of the first and the second video sources 15 and 25 on positions of the changed data of the frame information stored in the frame buffer 50.

An example of writing the changed data of the first and the second DPVL video sources on the positions of the changed data of the frame information stored in the frame buffer 50 will be described with reference to FIG. 3.

First, an “A” state of FIG. 3 is assumed under which the reference area displaying priority of the first video signal is set up as 100% and that of the second video signal is set up as 0%, through the user input unit 60, and the reference video data 10a of the first video signal is written as frame information 50a. At this time, the display controller 70 receives a first DPVL video signal corresponding to a first changed area 10c inputted from the first video source 15 and a second DPVL video signal corresponding to a second changed area 20c inputted from the second video source 25. According to this, the display controller 70 determines position information of the first and the second DPVL signals and writes first changed data 10c′ on the corresponding position of the first DPVL video signal of the frame information 50a stored in the frame buffer 50. The display controller 70 also writes second changed data 20c′ on the corresponding position of the second DPVL video signal of the frame information 50a stored in the frame buffer 50.

After writing the first changed data 10c′ and the second changed data 20c′ on the corresponding positions of the frame information 50a stored in the frame buffer 50, the display controller 70 reads out the frame information 50a comprising of the first changed data 10c′, the second changed data 20c′ and the reference frame information 10b′, and controls the display module 30 to display a video image according thereto.

When writing the changed data of each DPVL video signal on the corresponding positions of the frame information already stored, the display controller 70 determines whether the writing positions of the respective changed data have any overlapped area. As a result, when it is determined that there is any overlapped area, the display controller 70 writes the respective changed data on the frame buffer 50 with graduation according to the respective changed area video level information stored in the storage unit 72.

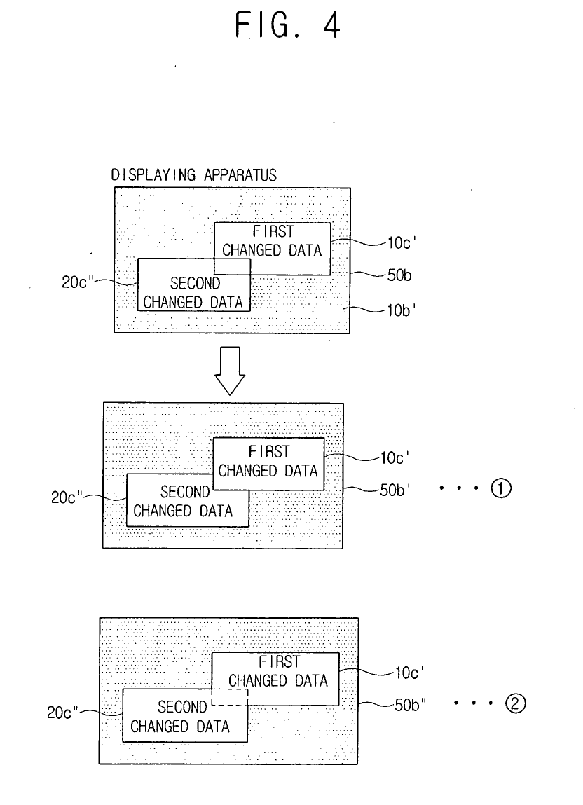

An example of writing the changed data of the first and the second DPVL video signals on the frame buffer 50 with graduation according to the changed area video level information, where the writing positions of the changed data are mutually overlapped as described above, will be described with reference to FIG. 4.

Under the assumption that the reference video data 10a of the first video signal is written as frame information, the displaying apparatus 100 receives the first DPVL video signal from the first video source 15 and the second DPVL video signal from the second video source 25.

When it is determined that there exists any mutually overlapped area between the changed data 10c′ and 20c″ of the first and the second video signals, the display controller 70 reads out the changed area video level information from the storage unit 72. Where the priority of the first DPVL video signal is set up as 100% and that of the second DPVL video signal is set up as 0%, referring to the changed area video level information (\textcircled{1}) of FIG. 4, the display controller 70 writes the first changed data 10c′ on the mutually overlapped area between the writing positions of the first changed data 10c′ and the second changed data 20c″. That is, the display controller 70 writes the first changed data 10c′ in a normal manner and writes only the other portion of the second changed data 20c″ than the overlapped area. According to this, the display controller 70 displays a video image by use of frame information 50b′ written with the changed data 10c′ and 20c″.

When the priority of the first DPVL video signal is set up as 0% and that of the second DPVL video signal is set up as 100%, referring to the changed area video level information, the display controller 70 writes the second changed data 20c″ in a normal manner and writes only the other portion of the first changed data 10c′ than the overlapped area.

In addition, when the priority of the first DPVL video signal is set up as 50% and that of the second DPVL video signal is set up as 50%, referring to the changed area video level information (\textcircled{2}) of FIG. 4, it is possible that the display controller 70 conducts a writing operation on the frame buffer 50 so that each of the video images of the first changed data 10c′ and the second changed data 20c″ on the overlapped area can be displayed semi-transparently all together. Accordingly, the display controller 70 displays video screens by use of frame information 50b″ written with the changed data 10c′ and 20c″.

The displaying apparatus according to an exemplary embodiment of the present invention can receive DPVL video signals inputted from plural video sources and display data of each DPVL video signal with graduation as set up by the user. That is, any confusion which may be caused by displaying data of the plural DPVL video signals may be prevented through the setup operation by the user.

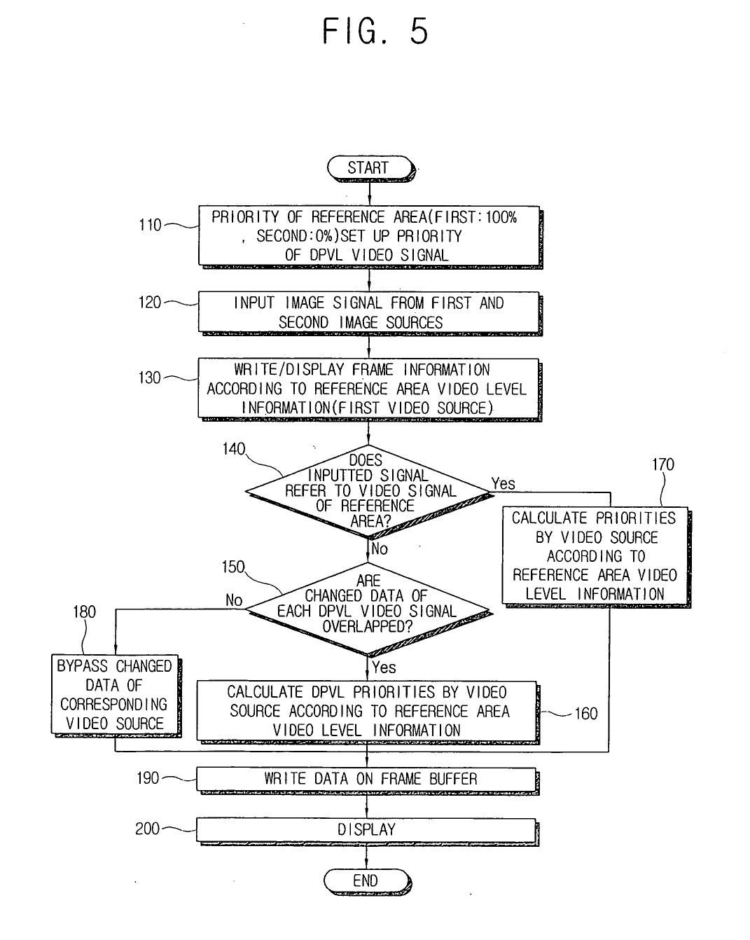

A control flow of the displaying apparatus with the above-described configuration will be described with reference to FIG. 5. A user first sets up the priorities (for example, first video signal priority: 100%, second video signal priority: 0%, and so on) for displaying the reference areas of the first and the second video signals and the priorities for the first and the second DPVL video signals, by manipulating the user input unit 60 at operation 110. According to this, the display controller 70 stores the reference area video level information and the changed area video level information in the storage unit 72. The first and the second video signals initially received from the first and the second video sources 15 and 25 are received at operation 120. The display controller 70 writes the reference video data of the first video signal whose priority is 100%, as frame information based on the reference area video level information stored in the storage unit 72, and controls the display module 30 so as to display a video image based on the written frame information at operation 130. After then, the display controller 70 determines whether the received first and second video signals correspond to the reference areas at operation 140. If the first and the second video signals corresponding to the reference areas are received, the display controller 70 calculates the priorities of the first and the second video signals based on the reference area video level information stored in the storage unit 72 at operation 170. Through this calculation, the display controller 70 can recognize that the priority of the first video signal is 100% and that of the second video signal is 0%. According to this, the display controller 70 writes the reference video data of the first video signal on the frame buffer 50 at operation 190. The display controller 70 displays a video image based ion the frame information of the frame buffer 50 at operation 200.

When it is determined that the first and the second video signals inputted at operation 140 do not correspond to the reference areas, that is, they refer to DPVL video signals, the display controller 70 determines whether there exists any overlapped area between changed data of the first and the second DPVL video signals at operation 150. Where no overlapped area exists, the display controller 70 bypasses the first changed data and the second changed data at operation 180, and writes them on the corresponding positions of the frame buffer 50 at operation 190.

However, where it is determined at operation 150 that there exists any overlapped area, the display controller 70 calculates the priorities of the first and the second DPVL video signals based on the changed area video level information stored in the storage unit 72 at operation 160. Through this calculation, the display controller 70 can recognize the priorities of the first and the second DPVL video signals (that is, the first DPVL priority: 0% and the second DPVL priority: 100%). According to this, the display controller 70 writes the second changed data of the second DPVL video signal on the corresponding position of the frame buffer 50 in a normal manner, and writes only the other portion of the first changed data of the first DPVL video signal than the overlapped area with the second changed data thereof at operation 190. On the overlapped position between the first changed data and the second changed data is written data, according to the priority set up by the user. Then, the display controller 70 displays a video image based on the frame information stored in the frame buffer 50 at operation 200.

As described above, the displaying apparatus according to an embodiment of the present invention receives DPVL video signals received from plural video sources, and displays data according to plural DPVL video signals. At this time, the displaying apparatus may prevent any confusion which may be caused in displaying data of plural DPVL video signals, through the user's setup operation.

According to embodiments of the present invention, there are provided a displaying apparatus capable of receiving DPVL video signals inputted from plural video sources and displaying data of the respective DPVL video signals, and a device to write data.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A displaying apparatus for communicating with a video source through a DPVL mechanism, comprising:
a plurality of interface units to receive video signals respectively received from a plurality of video sources supporting the DPVL mechanism;
a signal processing unit to process the respective video signals received from the plurality of video sources;
a frame buffer to store therein frame information corresponding to the respective video signals; and
a display controller to write changed data of each DPVL video signal received from the plurality of video sources and processed in the signal processing unit, on the positions of the frame information stored in the frame buffer, corresponding to each changed data, and displaying a video image according to the written frame information with the changed data of the respective DPVL video signals.

2. The displaying apparatus of claim 1, further comprising a user input unit to set up reference area for displaying priorities of each video signal inputted from the plurality of video sources by level,
wherein the display controller comprises a storage unit to store therein reference area video level information of each video signal set up through the user input unit.

3. The displaying apparatus of claim 2, wherein the display controller writes reference area data of each video signal received from the plurality of video sources, on the frame buffer as reference frame information with graduation, according to the reference area video level information stored in the storage unit.

4. The displaying apparatus of claim 3, wherein the reference area displaying priority of each video signal comprises a display density on reference area video.

5. The displaying apparatus of claim 4, wherein the user input unit further includes a function to set up the priorities of each DPVL video signal received from the plurality of video sources by level, and
the display controller stores changed area video level information of each DPVL video signal set up through the user input unit on the storage unit.

6. The displaying apparatus of claim 5, wherein the display controller determines whether there exists any overlapped area between writing positions of the respective changed data when writing the changed data of each DPVL video signal on the corresponding positions of the stored frame information, and as a result, when it is determined that any overlapped area exists, it writes the changed data on the corresponding positions of the frame information according to the stored changed area video level information.

7. The displaying apparatus of claim 6, wherein the priority of each DPVL video signal comprises a display density on changed area video of each DPVL video signal.

8. The displaying apparatus of claim 1, further comprising a user input unit to set up a display area of reference video by video source,
wherein the display controller comprises a storage unit to store therein display area information of the reference video by video source set up through the user input unit, and writes the video signal corresponding to the display area of the reference video by video source according to the display area information of the reference video by video source, on the frame buffer as reference frame information, among the video signals of the plurality of video sources.

9. The displaying apparatus of claim 8, wherein the user input unit further includes a function to set up the priorities of each DPVL video signal received from the plurality of video sources by level, and
the display controller stores changed area video level information of each DPVL video signal set up through the user input unit on the storage unit.

10. The displaying apparatus of claim 8, wherein the display controller determines whether there exists any overlapped area between writing positions of the respective changed data when writing the changed data of each DPVL video signal one the corresponding positions of the stored frame information, and as a result, when it is determined that any overlapped area exists, it writes the changed data on the corresponding positions of the frame information according to the stored changed area video level information.

11. The displaying apparatus of claim 10, wherein the priority of each DPVL video signal comprises a display density on changed area video of each DPVL video signal.

12. A device for writing data from a DPVL signal source through a DPVL mechanism on a frame buffer, comprising:
a plurality of interface units for receiving data signals received from a plurality of DPVL signal sources supporting the DPVL mechanism;
a processing unit for processing the data signals received from the plurality of DPVL signal sources; and
a controller for writing changed data corresponding to each DPVL signal inputted from the plurality of DPVL signal sources and processed in the signal processing unit, on the positions corresponding to the changed data of the frame information stored in the frame buffer.

13. The device of claim 12, further comprising a user input unit for setting up the priorities of each DPVL signal received from the plurality of DPVL signal sources,
wherein the controller comprises a storage unit for storing therein changed area level information of each DPVL signal set up through the user input unit.

14. The device of claim 13, wherein the controller determines whether there exists any overlapped area between writing positions of the respective changed data when writing the changed data of each DPVL video signal on the corresponding positions of the stored frame information, and as a result, when it is determined that any overlapped area exists, it writes the changed data on the corresponding positions of the frame information according to the stored changed area video level information.
